(19) United States
(12) Patent Application Publication
(10) Pub. No.: US 2009/0000553 A1
(43) Pub. Date: Jan. 1, 2009

(54) Method for the intensive cultivation of contaminant-free grasshoppers and their derivatives for human consumption

(75) Inventor: Julieta Ramos Elorduy Y Blasquez, Mexico D.F. (MX)

Correspondence Address: ERIC HANSCOM, 7395 PORTAGE WAY, CARLSBAD, CA, 92011, US

(73) Assignee: Universidad Nacional Autonoma de Mexico, et al.

(21) Appl. No.: 12/221,801

(22) Filed: Aug. 6, 2008

Related U.S. Application Data
(63) Continuation-in-part of application No. PCT/MX2007/000013, filed on Feb. 13, 2007.

(30) Foreign Application Priority Data
Feb. 14, 2006 (MX) PA/A/2006/001727

(51) Int. Cl. A01K 29/00

(52) U.S. Cl. 119/6.5

(57) ABSTRACT

The consumption of grasshoppers and their derivatives is an age-old tradition common in various places in Mexico and other countries, which has recently spread to developed nations. The consumption of different insects, and in particular of grasshoppers, constitutes an important source of protein within the diets of many communities. The traditional collection of grasshoppers for human consumption is done directly from cultivation fields, which are subjected to contaminants of various sorts due to the use of agrochemicals such as fertilizers, pesticides and herbicides, among others. It is well known that various compounds contained in these agrochemicals have toxic, harmful and accumulative effects in human beings.

This invention consists of an intensive contaminant-free process for raising grasshoppers and their derivatives for human consumption, from the cultivation of germplasm to the processing of the finished products ready for consumption. With said process, the market demand can be met, ensuring quality, uniformity, safety and product origin, with adequate, desired and controllable organoleptic and flavor characteristics.

The consumption of grasshoppers and their derivatives is an age-old tradition common in various places of Mexico and other countries, which has recently spread to developed nations. The consumption of different insects, and in particular of grasshoppers, constitutes as important source of protein in the diets of many communities. The traditional gathering of grasshoppers for human consumption is done directly from agriculture fields, which are treated with contaminants of various sorts due to the use of agrochemicals such as fertilizers, pesticides and herbicides, among others. It is well known that various compounds contained in these agrochemicals have toxic, harmful and accumulative effects in human beings. On the other hand, the supply of grasshoppers for human consumption has drastically decreased due to the effects of the emigration of male peasants that work the fields, as they are the ones with physical strength to carry the nets which can weight over 110 pounds. For these reasons, this current invention is of great importance to raise grasshoppers and their derivatives under controlled conditions, in a contaminant-free manner, for human consumption.

### PURPOSE OF THE INVENTION

This invention consists of an intensive contaminant-free process to raise grasshoppers and their derivatives for human consumption, from the cultivation of germplasm to the processing of the finished products ready for consumption. With this process, market demands can be met, ensuring quality, uniformity, safety and product origin, with adequate, desirable and controllable organoleptic, flavor qualities.

### BACKGROUND OF THE INVENTION

With respect to the customary ways of collection and consuming grasshoppers, the traditional method consisted of collecting these organism in nature, separating them by hand, rinsing them to eliminate vegetable residue, and cooking them at low temperatures in a clay pot with lemon juice, and salt, and over reed roots in fire until the liquid evaporated. Nonetheless, with the transformation and deterioration of the natural environment, the advent of monocultivation, and the use of agrochemicals, the original method for collecting grasshoppers for human consumption turned to agricultural areas, where grasshopper populations increased considerably, but where they became harmful due to the accumulation of toxic compounds from the agrochemicals used in cultivation.

The University of Arizona has an instruction manual on how to maintain live grasshoppers in a terrarium as pets, aimed at elementary and high school students, with which grasshoppers could be maintained for short periods of time. This instruction manual does not consider reproductive conditions necessary for these animals, nor does it include instruction on the types of plants that they prefer. It is also not focused on the cultivation of grasshoppers with specific characteristics which makes them fit for human consumption. That information is available in the following website: http://insected.arizona.edu/espanol/chapulinesrear.htm

Likewise, in the state of the technology, there exists a publication by the company INALIM Industria Alimentaria s.p.r. de r.i., which describes a process related to the collection and production of grasshoppers for human consumption. Nonetheless, the information contained is a general process for a technician in the field, and is not sufficiently specific to repeat the process. The production process described by this company refers to a process based on the collection of grasshoppers from agricultural fields for processing in an industrial plant and then commercialize them. The process described by this company does not consider that the grasshoppers should be free from contaminants, or that they have an adequate nutritional value, or any of the physical and organoleptic conditions that make them desirable for human consumption. This process is not based on the cultivation of grasshoppers, nor in obtaining a strain, or the cultivation of reproductive organisms, selected to maintain the germplasm. All of these characteristics make the process described by this company unfit to become a process which can control all variables, and which leads to a contaminant-free product fit for human consumption. They also do not consider quality control, which means it is a process with serious limitations, and very different from the invention subject of this proposal. This publication is available at http://www.foroconsultivo.org.mx/eventos-realizados/competitividad/tre/presentaciones/e02-sandoval.pdf

In the state of the art, a patent has also been found, CN1385064, which consists of a method to make various types of fodder by means of the harvesting of the locust Locusta sp. This process differs from the current invention for several reasons: It does not deal with the same Acrididae, because it uses a species of locust for harvesting as fodder, while the invention subject of this proposal consists of the contaminant-free raising of grasshoppers and its derivatives for human consumption.

### BRIEF DESCRIPTION OF THE INVENTION

The process of the contaminant-free process for raising grasshoppers and their derivatives for human consumption consists of the following stages:

1. Gathering of grasshoppers

2. Obtaining germplasm from grasshopper or other specimens.

3. Grasshopper rearing cycle in confined areas.

4. Raising reproductive grasshoppers within cages.

5. Raising and feeding of grasshoppers.

6. Obtaining germplasm from wild plants.

7. Elaboration of germinates

8. Preparation and processing of grasshoppers for sale.

9.

### DETAILED DESCRIPTION OF THE INVENTION

This invention consists of a contaminant-free process for raising grasshoppers and their derivatives for human consumption, which consists of the following stages:

1. Gathering of Grasshoppers

Large male and female grasshoppers are gathered from the field, preferably in a 2:1 female to male ratio. Specimens 2.5 to 3 cm long, 0.5 to 1 cm wide, and 0.5 to 0.8 cm tall, and on average 2.8 cm.±0.5 for the females and 2.5±0.5 for the males are selected. The adult grasshoppers must be healthy, vigorous and with a uniform color, predominantly green, but can be spotted yellow, brown of black. The grasshoppers must be alert, recognizable by quick and vigorous responses to different stimuli, such as light, sound, contact, heat, food and water.

2. Obtaining Germplasm from Grasshoppers.

The process for obtaining germplasm outlined by this invention begins by placing the grasshoppers collected in the previous stage in cages or chambers. These cages must contain plants cultivated in a controlled contaminant-free environment, which contain hormonal precursors required for the insects to adapt and develop. These plants must be combined in order to ensure proper nutrition, as sunflowers, chaya, hierbabuena, thitonia among others are preferred.

The cages or chambers used must have ovipositor boxes in addition to the plants. These boxes must be made of a transparent material, and filled with sterilized soil or sand mixed with vermiculite. The proper proportions are one part vermiculite to two parts sand, or one part vermiculite to three parts dirt. The soil or sand must be loose, and the moisture must be maintained at 60 to 65%.

Copulation should begin as soon as the grasshoppers are transferred to the cages or chambers, and oviposition should occur after the fourth or fifth day. Oviposition consists of females placing their abdomen in the loose, moist soil and depositing oothecas, which house the eggs. The number of oothecas per box is counted once the females have oviposited, and the soil or sand is checked for perforations which indicate that it is time to begin incubating the eggs.

In order to begin incubation of the eggs, the boxes containing the oothecas are removed and placed in a calibrated oven heated to 15-34° C.±2° C., and preferably maintaining the temperature at 28±2° C., with a relative humidity which may vary from 30 to 87% RH., and preferably at 70% RH. The incubation period lasts 150 days, and the moisture and temperature conditions must be checked daily to avoid desiccation of the oothecas, or formation of fungi, and to detect the moment of birth of the first nymphs, known as Nymph I. The oothecas become obscure once the nymphs approach birth. Once the grasshoppers are born, they are fed on different plants depending on their developmental stage, and they are raised in specific areas, as described in the next section. Nymphs I must adapt to ambient temperature before being transferred to the corresponding area.

Special care must be placed on this part of the process, as it is fundamental to ensure the desired characteristics of these individuals for human consumption, and because they will reproduce to create future generations, denominated “Strain A”. Further on, the grasshoppers of this strain will undergo various genetic, nutritional and organoleptic analysis to ensure that future generation are fertile, uniform and controlled to maintain certain characteristics.

3. Grasshopper Rearing Cycle in Confined Areas.

The five stages of grasshoppers known as Nymph I, Nymph II, Nymph III, Nymph IV, and Nymph V, and including the adult stage, are raised in defined areas of land, with the food species previously grown in a nursery. This may vary from one field to another, depending on the stage of the grasshoppers. To get an adequate biomass, the field must be at least one hectare.

The field is divided into four zones, of varying sizes and housing different stages of grasshopper development. These areas must be covered with mosquito netting at different heights to prevent individuals from escaping or increasing their territory, and to ensure that they only migrate to the next area when allowed to do so after they reach the appropriate developmental stage. The areas will be joined by removable frames or screens, made with the same mosquito netting, which are removed when necessary. Each area must have uniformly distributed bioprotectors during the night, made out of sponges and other materials.

The first field will have cages housing Nymphs I, once they have undergone the adaptation period from incubation to ambient temperature. The cages can be of several sizes, although it is recommended that they measure 40×40×40 cm. with wooden or aluminum walls covered in marquisette or mosquito netting. They are opened by sliding a removable side so that the Nymphs I can exit freely and continue their development on their own in this field until they reach Nymph II stage. These Nymphs will be left in this area for approximately 28±5.8 days, until they reach their next stage of development, Nymph II. When this occurs, the Nymphs III will be released into the second area, where they will remain for approximately 13.9±6 days. Once this stage has ended and they have reached Nymph IV, they will be released into the third area, where they will remain for approximately 21±5 days, until they reach Nymph V. Once this occurs, the last division between the areas will be removed, and they will be released into the fourth area, and they will begin to be attracted by new plants in order to obtain better nutrition. They will remain in this area for 23.5±4.8 days, after which they will move on to adult stage.

Adults are distinguished by the following characteristics: 2.5 to 3 cm long×0.5 to 1 cm wide and 0.5 to 0.8 cm tall, and an average of 2.8 cm.±0.5 for the females, and 2.5±0.5 for the males. The adult grasshoppers must be uniform in color, predominantly green, but also yellow, brown or black. The grasshoppers must be alert, recognizable by quick and vigorous responses to different stimuli, such as light, sound, contact, heat, food and water. The nutritional value of these specimens is high in protein, containing from 62% to 67% dry matter protein, which is verified by means of bromatological analyses to randomly sampled individuals from this group.

Grasshopper sexual maturity occurs 3 to 6 days after reaching adult stage, at which time they can begin copulation, although adults have a life span of 86 to 104 days. The grasshoppers are left in the fourth area until they copulate, and deposit their eggs, either on the ground or in special boxes placed specifically for this purpose. Once the grasshoppers are observed to have ceased copulation, and that the females are no longer laying eggs, they are collected to be processed as a final product, and the individuals that will be used for reproductive purposes are selected and separated.

The collection is carried out using nets made out of cotton fabric, and the grasshoppers are stored in cages to be processed later.

The oothecas oviposited in the fourth area, which now becomes area 1 for the new cycle, will be used until they reach Nymph Ill. In order to adequately feed them, the necessary plants will be introduced into this area in metallic pots with small legs to not damage the eggs deposited on the ground. For this cycle, the same care and controls that were described for the first area must be implemented for the fourth area.

Once the Nymphs have reached Nymph II, the steps described in the third stage are carried out, and the fields start being used in the opposite direction. All four fields are used cyclically, starting as stages 1, 2, 3 and 4 for the first cycle and all odd cycles, and are used in the opposite direction for all even cycles, so that the fourth field in the odd cycles is the first field in the even cycles, the third field in the odd cycles is the second in the even cycles, and so on.

Grasshoppers can be commercialized from Nymphs I until the adult stage, because there is a market for them. The grasshoppers commercialized according to the production and sales program established will be collected with the same netting method.

4. Raising Reproductive Grasshoppers within Cages.

As mentioned in the section “Obtaining germplasm from grasshopper”, this invention includes obtaining, selecting and conserving grasshopper genetic material to maintain and improve the genetic quality of the population, based on a cyclic selection of the individuals with the best physical and reproductive characteristics. To guarantee the species characteristics, and avoid long term genetic alterations, new grasshoppers will be added at the beginning of each cycle, as well as special reproductive grasshoppers. The process for raising these reproductive grasshoppers is described below:

A number of oothecas deposited by the adult grasshoppers and treated as described in the second stage are selected to be a part of the reproductive group for the next cycle. The oothecas selected are incubated in the conditions described in the second stage, and once the Nymphs I are born, they are reared in captivity, using different sized cages built of lightweight wood or aluminum, and covered with mosquito netting or marquisette and with two levels. The floor of the first level is made of copper mesh which permits the excrement to drop to the second level where it can be collected for use as fertilizer, also freeing the cage from contaminants. The frame which supports the bottom and top of the cage must also be made of lightweight wood, and the top must have an opening of approximately 25 cm in diameter with a removable cover to make observations, take pictures and change the food ad libitum.

Plastic boxes with the food plants and some moisture-retaining material are placed on the bottom of the cages, and the stalks must remain in water so the grasshoppers have adequate food. One of the sides of the cages must slide, to allow the distribution of the grasshoppers into other, joined and empty cages, in order to maintain an optimal number of individuals according to their developmental stage. Once the grasshoppers have distributed themselves evenly in the different cages, the sliding sides will once more be inserted, separating the cages.

Once the individuals reach Nymph V towards the end of their development, conditions are prepared for egg lying once copulation begins. This means introducing ovipositor boxes filled with sterilized river sand mixed with vermiculite in the proportions mentioned in the second stage. A thin tube or funnel is inserted in one of the corners of the box to drain the water to control humidity of the sand and maintain the oothecas in ideal conditions, avoiding excess humidity or water penetration to them. These boxes must be transparent to monitor the oothecas and their development through the sides.

Once the females have deposited the eggs, the boxes are removed with the oothecas and passed to the incubation stage. Once the incubation stage ends and the first Nymphs of that cycle are born, the largest and most active of these are selected and transferred to cages that will house the next first generation of reproductive grasshoppers, denominated F1. The rest will be placed in the first field, and subsequently in the next fields according to their developmental stages as explained in the third stage. This is repeated continuously with each cycle.

5. Raising and Feeding of Grasshoppers.

The diet of the immature or Nymphal grasshoppers is based on sprouts and plants grown in soil under controlled condition for subsequent stages, which must posses the hormonal precursors to allow a greater grasshopper reproduction.

Nymphs I and II prefer to feed on corn or wheat sprouts from certified seed, or other soft leaved plants, such as Matricaria chamomilla or Bidens pilosa.

Nymphs III are fed plants found in the region where the grasshoppers are being raised, such as hay, and different species of Bidens, in particular B. pilosa, B. bicolor, B. squamosa and/or B. oaxacana or plants known as Santa Maria, Chrysantenum parthenium (Chrysanthemum), Piper sanctus (Holy Leaf, Salvia leucantha (Pluma de Santa Teresa) Taxetes lucida (Marigold) and Crotalaria longirostrata (Chipilin).

Nymphs IV feed on plants found in the region, preferably hay, Taraxacum officinalis (Dandelion), Calendula officinalis (Calendula) and different species of the genus Solanum endemic to Oaxaca.

The Nymphs V and the adults feed on a mix of plants found in the region, preferably hay with Helianthus annus (Wild sunflower), Gigant\acute{p}n, Tithonia spp., Cnidoscolus chayamansa (Chaya de Castilla) and Rumex crispus (Lengua de Vaca).

Polycultures will be used in order to avoid the use of agrochemicals in the cultivation of the plants with which the grasshoppers will be fed, and also to foster the presence of natural enemies should a competitor to the grasshoppers appear. All care must be placed in ensuring healthy plants able to withstand the presence of other insects.

6. Obtaining Germplasm from Wild Plants.

In order to have the necessary plants to feed the grasshoppers, and for these to be free from agrochemicals, a nursery will be used to grow the plants mentioned in the previous section. Once the seeds are gathered, they are quickly rinsed in chlorinated water, and dried in a drying chamber at low temperatures of 160 to 23° C.±2° C., and preferably at 18° C. One part of the seeds is stored as germplasm for future cycles, and another is cultivated.

For the cultivation of the plants, the soil is prepared, controlling the type of soil, the techniques used to turn the dirt, to maintain uniform depth and humidity, as well as for organic fertilization, factors which are crucial to the germination and growth of diverse plants from seed, such as: soft leaved plants of different species of Bidens, hay, Santa Maria, Diente de León, Calendula and Chaya. Wild and domestic sunflowers, Marigolds, Tithonia, among others are also required.

7. Elaboration of Germinates

The elaboration of germinates takes place in a chamber or area controlling the following variables:
Temperature: 230 to 35° C.±2° C. and preferably 28° C.
Relative Humidity: 34% to 87%, preferably 65%.
Light exposure period: 12 hours.

The corn or wheat seeds are placed in trays containing humid paper, and placed at different levels. They are sprayed to maintain constant humidity and allow growth until they are 15 to 20 cm. tall. Germinates are removed from the trays and separated to feed the first nymphs.

8. Preparation and Processing of Grasshoppers for Sale.

With this invention, grasshoppers collected to be processed for human consumption are similar in size, color, nutritional value, and will be free of contaminants and toxic compounds. The preparation process consists of the following steps: collection, first selection, fasting, cooling, second selection, cooking, drying, third selection, preparing, seasoning, packing and labeling.

Sweeping nets are used in the collection process, although it can also be done manually, or by cutting and shaking the plants. It must be done during the coolest hours of the day, because grasshoppers are poikilotherms (=cold-blooded), which means their activity depends on the ambient temperature and they are less active when it is colder. Once they are collected, they are stored in a cage, and left to fast for a day in order to eliminate the contents of the digestive tract and avoid unpleasant and bitter flavors.

After the fast, the grasshoppers are placed in a cooling chamber in order to immobilize them and discard the grasshoppers that don't meet the desired characteristics. They are then lightly rinsed to eliminate traces of feces or leaves, and left to be boiled, baked or fried.

Grasshoppers are cooked in containers of any material, although stainless steel is preferred, in boiling salt water. They are constantly stirred over a low flame until they turn red, which happens after 3 to 10 minutes, and generally after 5 minutes. At this time they are removed using large metallic strainers with a wide diameter, and transferred to rectangular frames 80×40 cm with a 1 mm mesh and are gently shaken to eliminate water. They are then placed in a drying oven at a temperature of 35° to 60°±3° C., preferably 50° C., in order to not denature the protein. They are kept like this for two or three days.

Once the grasshoppers are dry, they are transferred to a table to be sorted through manually, and grouped according to size to form uniform groups, and discard individuals which do not meet the quality standards. They are then prepared and seasoned, by adding lime juice, ground garlic, various forms of chilies and peppers, among others. The proportion of the condiments may vary according to the desired final product. These grasshoppers are ready for packing and commercializing.

The process described by this invention is meant to be uniform, reliable and easily reproduced with any strain of grasshoppers. Quality controls must be implemented at each stage of the process in order to achieve this end.

### EXAMPLE

One hundred adult male grasshoppers and 300 adult female grasshoppers are collected from the field using a sweeping net. Specimens measuring 2.5 to 3 cm long×0.5 to 1 cm wide and 0.5 to 0.8 cm tall, and averaging 2.8 cm.±0.5 for females 2.5±0.5 for the males, are collected. The adult grasshoppers must be healthy, vigorous and with a uniform color, predominantly green, but also yellow, brown of black. The grasshoppers must be alert, recognizable by quick and vigorous responses to different stimuli, such as light, sound, contact, heat, food and water.

That same day, the grasshoppers selected are placed in cages containing various nutritional plants cultivated under controlled agrochemical-free conditions thanks to polycultures. These plants are: hay mixed with Helianthus annus (wild sunflower), Gigantón, Tithonia spp., Cnidoscolus chayamansa (Chaya de Castilla) and with Rumex crispus (Lengua de Vaca).

Before transferring the grasshoppers, ovipositor boxes are placed in the cages. These boxes must be made of a transparent material, and filled with sterilized soil or sand mixed with vermiculite. The proper proportions are one part vermiculite to two parts sand, or one part vermiculite to three parts dirt. The soil or sand must be loose, and the moisture must be between 60 and 65%.

Copulation should begin as soon as the grasshoppers are transferred to the cages or chambers, and oviposition should occur after the fourth or fifth day. Oviposition consists of depositing oothecas in the loose, moist soil. Each ootheca houses around 30 eggs, and once the females have oviposited, they are removed from these boxes. The soil or sand is checked for recent perforations, and the number of oothecas per box is counted.

In order to begin incubation of the eggs, the boxes containing the oothecas are removed and placed in a calibrated stove heated to a temperature of 28±2° C., with a relative humidity of 70% RH. The incubation period lasts 150 days because they have days when development pauses, and the moisture and temperature conditions must be checked daily to avoid desiccation of the oothecas, or formation of fungi, and to detect the moment of birth of the first nymphs, known as Nymph I. The oothecas become obscure once the nymphs approach birth.

Approximately 7200 Nymphs I will result from the incubation of these oothecas. A 20% mortality rate is expected due to different natural causes when they reach adult stage. The grasshoppers are fed on different plants depending on their developmental stage and are raised in confined fields as is explained in the next section. Before the Nymphs I are transferred to these fields, they must adapt to ambient temperature in a controlled manner. Once they have grown and are adults, 300 females and 100 males are selected to reproduce and give way to next generation, named “Strain A”. These grasshoppers are laboratory reproductive specimens, and they undergo various genetic, nutritional and organoleptic analyses in order to ensure that future generations will be fertile, uniform and controlled to maintain certain characteristics.

In order to ensure the adequate development of the grasshoppers, the Nymphs I and II prefer to feed on corn or wheat sprouts from certified seed, or other soft leaved plants, and on plants grown under controlled conditions for subsequent stages which must posses the hormonal precursors to allow a greater grasshopper reproduction. Once the Nymphs I adapt to ambient temperature, they are transferred to the corresponding field, and are fed on corn or wheat sprouts from certified seed, or other soft leaved plants, such as Matricaria chamomilla or Bidens pilosa for 15.5±7 days for the Nymphs I and for 12.5±4.7 days for the Nymphs II. After this stage, the Nymphs III are released into the second field, where they will remain for 13.9±6 days, and they fed on hay, and different species of Bidens, in particular B. pilosa, B. bicolor, B. squamosa and/or B. oaxacana or plants known as Santa Maria, Chrysantenum parthenium (Chrysanthemum), Piper sanctus (Holy Leaf), Salvia leucantha (Pluma de Santa Teresa) Taxetes lucida (Marigold) and Crotalaria longirostrata (Chipilin). Once they have become Nymphs IV, they are released into the next field and are to be fed on hay, Taraxacum officinalis (Dandelion), Calendula officinalis (Calendula) and different species of the genus Solanum endemic to Oaxaca for 21±5 days. After this period, they are Nymphs V, and are released into the fourth and last field, where they remain for 23±5 days and feed on a mix of plants found in the region, preferably hay with Helianthus annus (Wild sunflower), Gigantón, Tithonia spp., Cnidoscolus chayamansa (Chaya de Castilla) and Rumex crispus (Lengua de Vaca). Three to five days after they reach adulthood, they begin to copulate, and conditions are set for oviposition by maintaining the soil loose and moist, and placing oviposition boxes as previously described. Once oviposition concludes, a new cycle begins. The oviposition boxes are collected and 100 ootheca containing approximately 3000 eggs are selected. Approximately 2400 eggs will remain after the 20% mortality rate to be laboratory reproductive specimens.

Grasshoppers can be commercialized from Nymphs I through the adult stage, but in this example they are raised until they reach adulthood, thus obtaining 70,600 grasshoppers. This represents fresh weight biomass of 42.360 kilograms after discounting the 20% mortality rate.

Adult grasshoppers undergo various genetic, nutritional and organoleptic analyses in order to ensure that future generations will be fertile, uniform and controlled to maintain certain characteristics.

The results of these analyses are presented in the following tables:

### Nutrition Value of Grasshopper

### Sphenarium purpurascens Ch.

Macro elements of Edible Grasshoppers
Sphenarium (g/100 g product)

| | Protein | Minerals | Fat | Fiber | Carbohydrates |
|---|---|---|---|---|---|
| S. purpurascens | 58.33 | 16.49 | 7.46 | 8.68 | 9.02 |
| Sphenarium spp. | 71-35 | 2.41 | 6.52 | 11.58 | 8.11 |
| S. spp | 77.13 | 4.22 | 2.44 | 12.17 | 4.01 |
| S. spp | 67.8 | 11.47 | 4.87 | 10.51 | 4.65 |
| S. histrio = bolivari | 77.13 | 4.22 | 2.44 | 12.17 | 4.01 |
| S. purpurascens | 56.19 | 10.78 | 2.95 | 9.41 | 20.63 |

Amino acid Content of Edible Mexican
Grasshoppers (mg/16 mg N)

| Indispensable Amino acids | Sphenarium purpurascens |
|---|---|
| Isoleucine | 4.2 |
| Leucine | 8.9 |
| Lysine | 5.7 |
| Metionine+ | 2.5 |
| Cisterne | 1.8 |
| Total sulphurated amino acids | 4.3 |
| Phenylalanine+ | 10.3 |
| Tyrosine | 6.3 |
| Total aromatic amino acids | 16.8 |
| Treonine | 3.8 |
| Triptofane | 0.65 |
| Valine | 5.7 |
| Total indispensable amino acids | 49.85 |
| Histidine | 1.8 |
| Aspartic Acid | 8.5 |
| Serine | 6.1 |
| Glutamic Acid | 11.0 |
| Proline | 7.2 |
| Glicine | 7.8 |
| Alanite | 10.4 |
| Arginine | 6.0 |
| Total dispensable amino acids | 57.9 |

Caloric Value of Edible Grasshoppers from the State of Oaxaca

| | Kilocalories/100 grs. |
|---|---|
| Sphenarium histrio | 363 |
| Sphenarium purpurascens | 404 |
| S. histrio and S. Purpurascens | 336 |
| Sphenarium spp. | 377 |
| Sphenarium spp. | 362. |

Approximate Digestibility Percentage
of Edible Mexican Grasshoppers

| | Dry matter | Protein |
|---|---|---|
| Sphenarium histrio | 83.15 | 85.63 |

Important Minerals Contained within Edible
Mexican Grasshoppers (g/100 g)

| | Minerals | Na | K | Ca | Zn | Fe | Mg |
|---|---|---|---|---|---|---|---|
| Sphenarium sp. | 2.40 | 0.109 | 0.044 | 0.051 | 0.060 | 0.028 | 0.728 |
| S. histrio | 4.79 | 0.426 | 0.422 | 0.096 | 0.021 | 0.023 | 0.744 |
| S. histrio, S. | 8.33 | 7.049 | 0.250 | 0.115 | 0.017 | 0.016 | 0.354 |
| Purpurascens | | | | | | | |
| S. purpurascens | 2.14 | 0.609 | 0.377 | 0.112 | 0.042 | 0.018 | 0.424 |
| S. spp. | 5.56 | 0.915 | 0.068 | 0.120 | 0.032 | 0.044 | 0.824 |

Vitamins Contained within Edible Mexican Grasshoppers

| | DU:I:/ | Thiamine | Riboflavin | Niacin |
|---|---|---|---|---|
| | 100 g | (mg/100 g) | (mg./100 g) | (mg/100 g) |
| Sphenarium spp. | 164.91 | 0.50 | 0.66 | 5.04 |
| S. purpurascens | | 0.27 | 0.59 | 1.56 |

Having sufficiently described the invention, and considering it a novelty, I claim as my exclusive property, the points contained in the following claims:

1. Contaminant-free process for raising grasshoppers and their derivatives for human consumption, which consists of the following stages:
a. Gathering of grasshoppers
b. Obtaining germplasm from grasshoppers.
c. Grasshopper rearing cycle in confined areas.
d. Raising reproductive grasshoppers within cages.
e. Raising and feeding of grasshoppers.
f. Obtaining germplasm from wild plants.
g. Elaboration of germinates
h. Preparation and processing of grasshoppers for sale.

2. Contaminant-free process for raising grasshoppers and their derivatives for human consumption, which according to claim 1, is characterized by the stage of grasshopper gathering which consist of selecting adult organism in the wild or obtained by captive breeding.

3. Contaminant-free process for raising grasshoppers and their derivatives for human consumption, in which according to claim 2, the selection of grasshoppers is characterized because a sexual ratio 2:1 is maintained, and size varies from 2.5 to 3 cm. long×0.5 to 1 cm. wide×0.5 a 0.8 cm. tall, and averaging 2.8±0.5 cm. for the females and 2.5±0.5 cm. for the males.

4. Contaminant-free process for raising grasshoppers and their derivatives for human consumption, in which according to claim 2, the selection of grasshoppers is characterized because they must be uniformly colored, predominantly green, with yellow, brown or black areas. Their activity must be alert, characterized by quick and vigorous responses to different stimuli, such as light, sound, contact, heat, food and water.

5. Contaminant-free process for raising grasshoppers and their derivatives for human consumption, in which according to claim 1, the stage of obtaining germplasm from the grasshoppers in characterized by raising them in adequate and controlled conditions in order to:
Promote copulation,
Obtain oothecas in the ovoposition boxes, and
Incubation of oothecas and eggs.

6. Contaminant-free process for raising grasshoppers and their derivatives for human consumption, according to claim 5, is characterized by the oviposition boxes which must be made of a transparent material, and filled with sterilized soil or sand mixed with vermiculite. The proper proportions are one part vermiculite to two parts sand, or one part vermiculite to three parts dirt. The soil or sand must be loose, and the moisture must be maintained at 60 to 65%.

7. Contaminant-free process for raising grasshoppers and their derivatives for human consumption, in which according to claim 5, incubation of the oothecas and the eggs is characterized because the temperature must be 15-34±2° C. and the relative humidity must remain between 30 and 87%.

8. Contaminant-free process for raising grasshoppers and their derivatives for human consumption, in which according to claim 5, incubation of the oothecas and the eggs is characterized because the preferred temperature is of 28±2° C. and the preferred relative humidity is of 70%.

9. Contaminant-free process for raising grasshoppers and their derivatives for human consumption, in which according to claim 5, incubation of the oothecas and eggs is characterized by a diapause period and takes place in 150 days.

10. Contaminant-free process for raising grasshoppers and their derivatives for human consumption, according to claim 1, is characterized because the rearing of grasshoppers takes place in different fields according to their developmental stage. They remain in each field for a certain period, and each field is prepared with various food plants grown under controlled, agrochemical-free conditions.

11. Contaminant-free process for raising grasshoppers and their derivatives for human consumption, according to claim 10, is characterized by the grasshopper rearing cycle in confined areas, during which the field is divided into confined areas, and must be joined by removable frames or screens, and have nightly bioprotectors.

12. Contaminant-free process for raising grasshoppers and their derivatives for human consumption, according to claim 11, is characterized by the grasshopper rearing cycle in confined fields, during which first field houses Nymphs I and II, until they reach Nymph III.

13. Contaminant-free process for raising grasshoppers and their derivatives for human consumption, according to claim 11, during the grasshopper rearing cycle in confined areas is characterized because the second field houses Nymphs III until they reach Nymph IV.

14. Contaminant-free process for raising grasshoppers and their derivatives for human consumption, according to claim 11, during the grasshopper rearing cycle in confined areas is characterized because the third field houses Nymphs IV until they reach Nymph V.

15. Contaminant-free process for raising grasshoppers and their derivatives for human consumption, according to claim 11, during the grasshopper rearing cycle in confined areas is characterized because the fourth field houses Nymphs V until they reach adulthood.

16. Contaminant-free process for raising grasshoppers and their derivatives for human consumption, according to claim 15, is characterized because the grasshopper rearing takes place in confined fields. In the fourth of these fields, the grasshoppers oviposit directly in the ground or in oviposition boxes previously placed there, and collected once oviposition ends.

17. Contaminant-free process for raising grasshoppers and their derivatives for human consumption, according to claim 1, is characterized because the rearing of reproductive grasshoppers in cages undergoes selection of the best individuals, formation and conservation of the grasshopper genetic material, to preserve and improve the genetic makeup of the population in regard to their physical and reproductive characteristics.

18. Contaminant-free process for raising grasshoppers and their derivatives for human consumption, according to claim 1, is characterized by the raising and feeding of grasshoppers, during which the different stages of grasshoppers are fed agrochemical free plants.

19. Contaminant-free process for raising grasshoppers and their derivatives for human consumption, according to claim 18, is characterized by the raising and feeding of grasshoppers, during which Nymphs I and II prefer to feed on corn or wheat sprouts from certified seed, or other soft leaved plants, such as Matricaria chamomilla or Bidens pilosa.

20. Contaminant-free process for raising grasshoppers and their derivatives for human consumption, according to claim 18, is characterized by the raising and feeding of grasshoppers, during which Nymphs III are fed plants found in the region where the grasshoppers are being raised, such as hay, and different species of Bidens, in particular B. pilosa, B. bicolor, B. squamosa and/or B. oaxacana or plants known as Santa Maria, Chrysantenum parthenium (Chrysanthemum), Piper sanctus (Holy Leaf), Salvia leucantha (Pluma de Santa Teresa) Taxetes lucida (Marigold) and Crotalaria longirostrata (Chipilin).

21. Contaminant-free process for raising grasshoppers and their derivatives for human consumption, according to claim 18, is characterized by the raising and feeding of grasshoppers, during which Nymphs IV feed on plants found in the region, preferably hay, Taraxacum officinalis (Dandelion), Calendula officinalis (Calendula) and different species of the genus Solanum endemic to Oaxaca.

22. Contaminant-free process for raising grasshoppers and their derivatives for human consumption, according to claim 18, is characterized by the raising and feeding of grasshoppers, during which Nymphs V and adult grasshoppers feed on a mix of plants found in the region, preferably hay with Helianthus annus (Wild sunflower), Gigantón, Tithonia spp., Cnidoscolus chayamansa (Chaya de Castilla) and Rumex crispus (Lengua de Vaca).

23. Contaminant-free process for raising grasshoppers and their derivatives for human consumption, according to claim 1, is characterized by obtaining germplasm from plants grown in nurseries or agrochemical free fields.

24. Contaminant-free process for raising grasshoppers and their derivatives for human consumption, according to claim 23, is characterized by obtaining germplasm from wild plants, during which the seeds are gathered, quickly rinsed in chlorinated water, and dried in a drying chamber at low temperatures of 160 to 23° C.±2° C., and preferably at 18° C.

25. Contaminant-free process for raising grasshoppers and their derivatives for human consumption, according to claim 1, is characterized by elaboration of germinates, during which temperature is maintained at 23° to 35° C.±2° C. and preferably 28° C., relative humidity at 34% to 87%, preferably 65%, and they are exposed to light for 12 hour periods.

26. Contaminant-free process for raising grasshoppers and their derivatives for human consumption, according to claim 25, is characterized by elaboration of germinates, during which seed is placed in humid soil and sprayed to maintain humidity until the plants are 15 to 20 cm. tall.

27. Contaminant-free process for raising grasshoppers and their derivatives for human consumption, according to claim 1, is characterized by the preparation and processing of grasshoppers for sale, which consists of the following steps: collection, first selection, fasting, cooling, second selection, cooking, drying, third selection, preparing, seasoning, packing and labeling.

28. Contaminant-free process for raising grasshoppers and their derivatives for human consumption, according to claim 27, is characterized by the gathering of grasshoppers for sale, which is done manually or with sweeping nets, and it must be done during the coolest hours of the day.

29. Contaminant-free process for raising grasshoppers and their derivatives for human consumption, according to claim 27, is characterized by the grasshoppers fasting for a day to eliminate the contents of the digestive tract.

30. Contaminant-free process for raising grasshoppers and their derivatives for human consumption, according to claim 27, is characterized by placing the grasshoppers in a cooling chamber in order to immobilize them and discard the grasshoppers that don't meet the desired characteristics.

31. Contaminant-free process for raising grasshoppers and their derivatives for human consumption, according to claim 27, is characterized by then lightly rinsing the grasshoppers to eliminate traces of feces or leaves.

32. Contaminant-free process for raising grasshoppers and their derivatives for human consumption, according to claim 27, is characterized by cooking the grasshoppers in containers of any material, although stainless steel is preferred, and in boiling salt water, over a low flame, until they turn red.

33. Contaminant-free process for raising grasshoppers and their derivatives for human consumption, according to claim 32, is characterized because the grasshoppers can be boiled, baked or fried.

34. Contaminant-free process for raising grasshoppers and their derivatives for human consumption, according to claim 27, is characterized because the grasshoppers are then placed in a drying oven at a temperature of 35° to 60°±3° C., preferably 50° C., in order to not denature the protein. They are maintained under these conditions for two or three days.

35. Contaminant-free process for raising grasshoppers and their derivatives for human consumption, according to claim 27, is characterized by the third selection process, during which the grasshoppers are selected manually, and sorted according to size into uniform groups.

36. Contaminant-free process for raising grasshoppers and their derivatives for human consumption, according to claim 27, is characterized because the grasshoppers are then prepared and seasoned, by adding lime juice, ground garlic, various forms of chilies and peppers, among others.
